(19) United States
(12) Patent Application Publication
(10) Pub. No.: US 2015/0161614 A1
(43) Pub. Date: Jun. 11, 2015

(54) System and Method for Processing Donations

(71) Applicant: ABUNDANTWHALE COMPANY LIMITED, Hong Kong (HK)

(72) Inventor: Rick Li-Kei Tsing, Hong Kong (HK)

(73) Assignee: ABUNDANTWHALE COMPANY LIMITED

(21) Appl. No.: 14/535,317

(22) Filed: Nov. 6, 2014

(30) Foreign Application Priority Data
Dec. 10, 2013 (HK) 13113712.5

(51) Int. Cl. G06Q 20/42; G06Q 30/02; G07C 13/00; G06Q 20/40

(52) U.S. Cl. CPC G06Q 20/42; G06Q 20/40; G06Q 30/0279; G07C 13/00

(57) ABSTRACT

The present patent application provides a convenient and efficient system for processing donations. The system includes a donation processing platform which manages a plurality of fund accounts that can be classified into private funds and public funds. Users can use different user devices such as computers, smart phones or PDA to communicate with the donation processing platform. As system members of the donation processing platform, the users can make donations in the system, apply for fund and approve the application of fund for certain cases. By using the system of the present patent application, it is easy to manage the donations and applications of fund.

### CROSS-REFERENCE TO RELATED APPLICATIONS

This application claims the benefit of Hong Kong Patent Application No. HK13113712.5 filed on Dec. 10, 2013; the contents of which is hereby incorporated by reference.

### TECHNICAL FIELD

This patent application relates to a network communication platform, and in particular a system and method for processing donations.

### BACKGROUND

Donations are popular in the fields of charity and commerce. However, it is difficult to manage the fund of donations. A user-friendly and direct donation method for people to create and manage their own funds on one platform/system is not available. It is desired to distribute the funds to specific areas efficiently, connect to what people are helping, facilitate the donation process and application process of fund, and give direct approval of granting money to a specific destination of a recipient.

### SUMMARY

Accordingly, the present patent application, in one aspect, is a system for processing donations. The system comprises a donation processing platform and user devices for communicating with the donation processing platform via a data communication channel. The donation processing platform manages a plurality of fund accounts open for applications by users who are system members of the donation processing platform. The users access to the donation processing platform through the user devices. The users have different right and restriction due to different types of system members. The approval of applications is made under different criteria based on different categories of the fund accounts. If the application is approved, approved amount is first transferred to a third party account of an organization or a person responsible for delivering the approved amount to a user account of the user of the application. Donations, applications and approval of the applications are made by the system members.

In an exemplary embodiment of the present patent application, the different types of system members are general member, donor and applicant. A general member is a system member who does not have any donation or application. A donor is a system member who makes at least one donation. An applicant is a system member who has made at least one application. The users are capable of being as multiple types of system members simultaneously.

In another exemplary embodiment, the fund accounts are classified into private funds and public funds. Private funds have personal funds and group funds. A personal fund is created by a donor. The personal fund is managed by the donor personally and approval of application of the personal fund is made by the donor. A group fund is created by at least one donor who has administration authority of the group fund. The group fund is managed by a specific group and approval of application of the group fund is made by members in the specific group. A public fund is created by the donation processing platform. Approval of application of the public fund is made by voting of the system members under a predefined rule. The predefined rule is that the application of the public fund is approved if and only if approval votes are equal to or more than 20,000 and disapproval votes are equal to or less than 500.

In another embodiment, management and operation of the donation processing platform are done by authorized administrators. The donations are reviewed and approved by the authorized administrators while applications are previewed by the authorized administrators before publishing on the donation processing platform.

In yet another embodiment, a system member is able to view applications in the donation processing platform, make comments on the applications and report hidden fact and lying to the donation processing platform to prevent dishonest applications and unnecessary waste of funds.

In a further embodiment, the donation processing platform supports filtering and sorting of applications based on input of the system members. Results of filtering and sorting of the applications includes summary of specific applications and are linked to corresponding presentation pages of the specific applications.

In another embodiment, the donation processing platform is housed in a local server or a cloud server which is an integration of multiple servers connected by wired or wireless means. The user devices comprise computers and mobile devices. The computers comprise desktops and notebooks that run operating system of WINDOWS or OS X. The mobile devices comprise PDA, tablet computers and smart phones that run operating system of IOS or ANDROID. The data communication channel comprises Internet and mobile network of GSM, GPRS, CDMA or WIFI.

In another aspect, the present patent application is a method for processing donations comprising the steps of: (a) providing a donation processing platform which manages a plurality of fund accounts open for applications by users who are system members of the donation processing platform; (b) accessing to the donation processing platform through user devices via a data communication channel; (c) logging into the donation processing platform as system members; and making donations, applications and approval of the applications by the system members. Users have different right and restriction due to different types of system members. The approval of the applications is made under different criteria based on different categories of the fund accounts. If the application is approved, approved amount is first transferred to a third party account of an organization or a person responsible for delivering the approved amount to a user account of the user of the application.

The system is open to users who are interested in making donations or applying for funds. The system provides flexibility for the users since a user can be a donor and an applicant simultaneously. The user may have his/her own fund account used to help other people while he/she may apply for other funds in the system for his/her own needs such as research or study. The system also provides a fair platform for users as the system members can review published cases on the donation processing platform and vote for approval or disapproval of applications of public funds. There are various funds available to the users in the donation processing platform that can help different people. The filtering and sorting functions facilitate the mapping between right people and right funds. In addition, the system is highly efficient because the donations, applications and approval are done by the users themselves.

### BRIEF DESCRIPTION OF FIGURES

FIG. 1a shows the donation processing system in one embodiment of the present patent application.

FIG. 1b illustrates the flow direction of information collected and generated through Internet to the platform in one embodiment of the present patent application.

FIG. 2a illustrates the features available for each type of membership in one embodiment of the present patent application.

FIG. 2b is a flowchart of the operation process of different memberships in one embodiment of the present patent application.

FIG. 3 is a flowchart of the process of an application of fund in one embodiment of the present patent application.

FIG. 4 is a flowchart of the process of donation in one embodiment of the present patent application.

FIG. 5 shows the public assessment process in one embodiment of the present patent application.

### DETAILED DESCRIPTION OF THE EMBODIMENTS

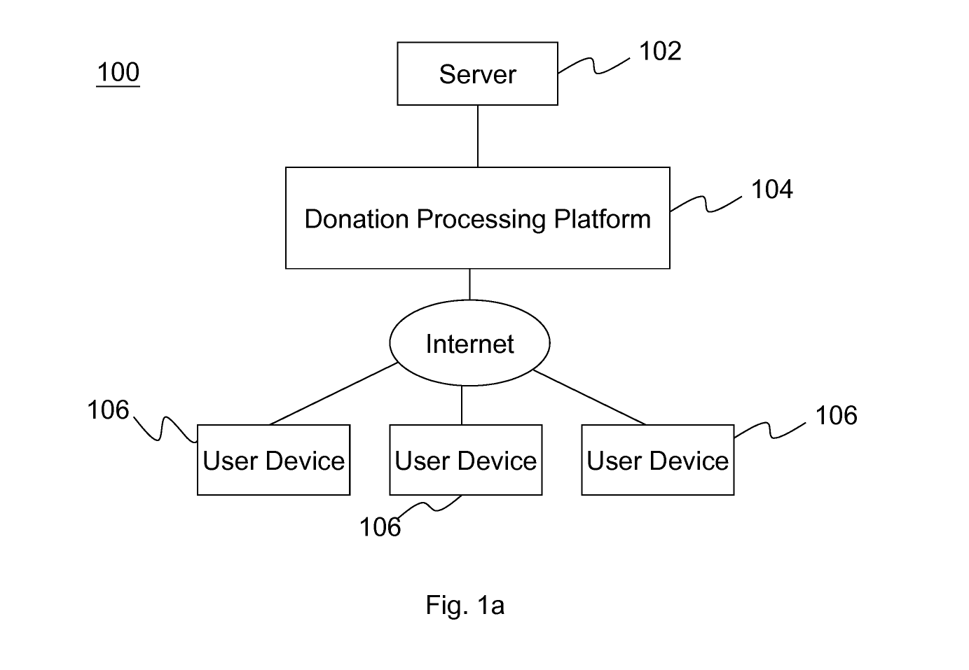

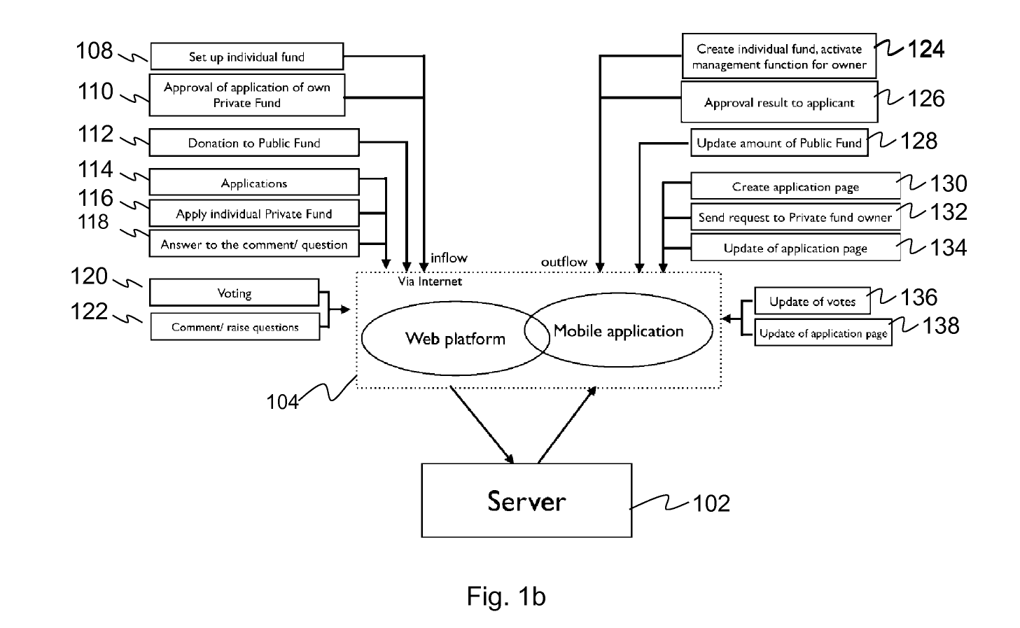

Referring now to FIG. 1a, the donation processing system 100 in one embodiment of the present patent application is shown. The donation processing system 100 includes server 102, a donation processing platform 104 and user devices 106. The donation processing platform 104 manages and controls the donation processing system 100. The donation processing platform 104 is housed on a server 102 which can be a local server or a cloud server and the server 102 can be a single server or an integration of multiple servers through wired or wireless connection. The donation processing platform 104 is an electronic platform used to handle donations and application thereof, and it manages fund accounts. The donation processing platform is open and interactive. “Open” means that it is open to any users and is without right limitation. Users who are interested in the donation processing platform 104 can register in the platform to become members. “Interactive” means that once a user becomes a member of the donation processing platform 104, the user can donate to the fund accounts of the platform, apply for funds of the platform, browse and evaluate the applications of funds, and has the right of vote so as to decide whether to approve the applications of funds. In other words, members of the donation processing platform 104 can fully interact with the platform, i.e. participating in donations and applications of funds. User devices 106 include computers or mobile devices, etc. Computers include desktops and notebooks that run operating system of WINDOWS or OS X. Mobile devices include smart phones that run IOS or ANDROID, PDA devices and tablet computers. The system interfaces for the user devices 106 to connect to the donation processing platform 104 include web interface and application interface. The user devices 106, e.g. computers, can access to the donation processing platform 104 directly based on the login webpage of the donation processing platform 104. The user devices, e.g. tablet computers, can also access to the donation processing platform 104 via applications such as an IOS application. The user devices 106 get access to the donation processing platform 104 via a data communication channel which includes Internet or mobile network such as GSM, GPRS, CDMA or WIFI.

To use the system of the present patent application, the users need to register to become system members. The steps of registration are simple. If a user wants to be a member, he/she can use a user device 106 to connect to the donation processing platform via webpage or applications. Once the connection between the user device 106 and the donation processing platform 104 is built, the user device 106 can communicate with the donation processing platform 104 and data can be transferred therebetween. There is a registration button shown on the webpage or application, the user just need to click that button and then input the information such as username, address, contact telephone, email, etc. When the donation processing platform 104 collects the information, it will create a record in the database for that user, and then that user will become a system member. The database of the donation processing platform 104 records the information of the system members and other important data. The database can be stored in local storage or cloud storage.

The operation of the donation processing platform 104, the registration of system members and other administrative actions such as page generation and function activation etc. are handled by authorized administrators.

Based on the donations and applications of funds, the system members are classified into general members (GM), donors (DO) and applicants (AT). If a system member does not have any donation or application of fund, he/she is a general member. A general member can browse each application of fund in the donation processing platform 104, analyze the application of fund and make a vote as whether to approve the application. A general member may also ask the applicant questions, make a comment on the application and report special situation such as dishonest behavior. A donor is a system member who makes at least one donation while an applicant is a system member who has applied for at least one fund.

The donation processing platform 104 manages public funds and private funds. Public funds are run by public and they are usually created by the donation processing platform 104 beforehand. It is possible to create a single public fund or multiple public funds based on different needs and the nature of the donations, for example, a public fund used for medical charity and a public fund used for study. When donors put their donations in public funds, those donations will be managed by the public, i.e. the system members. In one embodiment, the management of public funds by system members is achieved by voting of system members so as to decide how to use the public funds. With respect to the public fund accounts, donors have the right to select which account to donate, choose the amount to be donated and vote for how to use the public funds, but the donors do not have administration authority of the public fund accounts.

A private fund is managed by a person or a group of persons. Based on the private request of the donor, the system can create a single or multiple private fund accounts for that particular donor. The donor can set specific usage for his/her private fund account(s). For example, if a donor has two private fund accounts A and B, he/she can set that account A is used for medical care and account B for another usage.

Private fund accounts can be created based on donors' own will. The donors can manage the private fund accounts freely when creating the accounts or after the creation, including confirming or amending the account names, adding donation, amending the description of the fund accounts and amending the setting of the accounts, etc. Individual donation record will be shown in the member profile of the donor. Private funds can be categorized into personal funds and group funds. A personal fund is an account managed by the donor personally and the fund using is controlled by the donor himself/herself. A group fund is managed by a specific group and the fund using is decided by members in that specific group. For group fund accounts, the administration authorities are on the donors who create those group fund accounts. Creators, i.e. the donors creating the accounts, can confirm or amend the account names and amend the setting the accounts which includes editing (adding/deleting/amending) group members and setting the decision right of fund donations, etc. The group member who has the decision right of fund donations has the authority to decide the fund using in the account. For public fund accounts, the default setting is public decision which means that the use of the funds is decided by voting of system members. For private fund accounts, however, the donors can select the types of decisions in the account setting. The creator of a personal fund account can select to decide the use of the fund on his/her own or to make the decision open to the public, i.e. the use of the fund is decided by voting of the public. The creator of a group fund account can select to decide the use of the fund based on the voting of group members or the system members. Group members of a group fund account are selected from the system members by the creator. The creator can add group members or delete group members at any time. Once becoming a group member of a specific group fund account, the group member has the right to vote for the specific group fund and also donate to that specific group fund (if doing so, this group member becomes a donor simultaneously).

A donor can also give his/her decision right to an agent. Usually, the approval of a personal fund account is decided by the creator while the approval of a group fund account is decided by voting of the group members selected by the creator of that group fund account. It is not necessary for all group members to vote. The voting condition can be set by the creator. To approve an application of the fund, the creator can set a condition that the application can be approved if 80% of the group members vote and agree the application, i.e. if there are 100 group members in a group fund account, then the application can be approved if 80 group members agree the application, otherwise the application will be disapproved or has to wait until the enough votes are attained. However, the creators or group members can select other system members as their agents. In this way, for private fund, the agent of the creator gets the right of approval, and for group fund, the agent of the group member can represent the group member to vote.

If the approval of a private fund account, i.e. a personal fund account or a group fund account, is decided by public, that private fund account is the same as a public fund account since it is managed by the public and the approval is decided by voting. In this case, the difference is that the private fund account open to the public has more flexibility for the donor, i.e. the creator, to set the account name, specific people to be help, etc. In addition, the creator of the private fund account can change the approval method from public voting to personal decision or group voting.

Referring now to FIG. 1b which illustrates the flow direction of information collected and generated through Internet to the platform in one embodiment of the present patent application. The users access to the donation processing platform 104 via Internet through web platform or mobile application. The information collected by the donation processing platform 104 will be stored in the sever 102. Once an inflow is detected by the donation processing platform 104, a corresponding outflow will be triggered and update will be done in the sever 102. For example, if a donor sets up an individual private fund in inflow 108 and make approval of the application of the private fund in inflow 110, corresponding outflows 124 and 126 will be triggered, i.e. the system will create an individual private fund and activate management function for the owner of that private fund in outflow 124 and the system will inform the applicant of the approval result in outflow 126. As shown in FIG. 1b, outflow 128 is the corresponding inflow of inflow 112. Outflows 130, 132 and 134 are the corresponding inflows of inflows 114, 116 and 118 respectively. In addition, outflows 136 and 138 are the corresponding inflows of inflows 120 and 122 respectively.

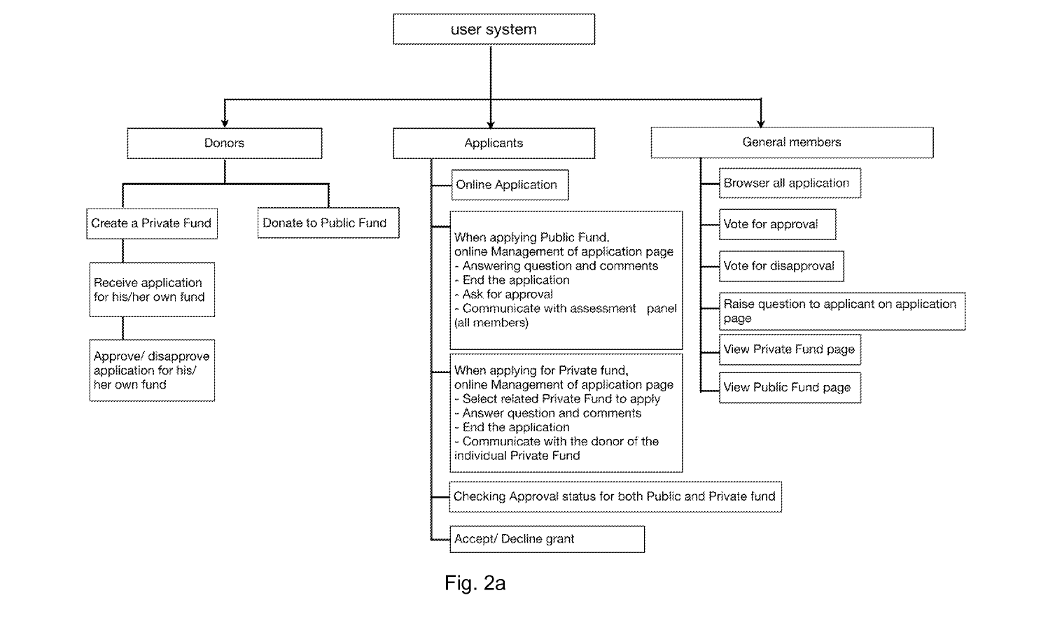

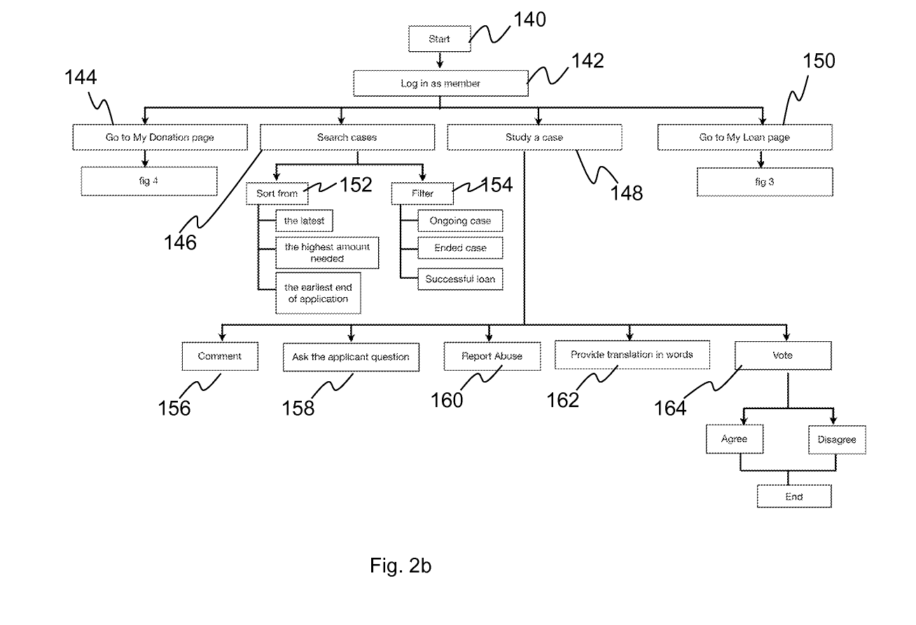

FIG. 2a illustrates the features available for each type of membership in one embodiment of the present patent application. Relevant descriptions have been mentioned above. For donors, they can create private fund accounts, receive applications for their own funds, approve/disapprove applications for their funds and donate to public funds. For applicants, they can apply for funding, answer questions and comments in the process of applications, check approval status for public funds and private funds and accept/decline grant, etc. For general members, they can browse the applications, vote for approval/disapproval, raise questions to the applicants and view private fund pages and public fund pages, etc.

If a user or a system member wants to make a donation, he/she can access the donation page, and then the system will ask what account to be created, i.e. private fund or public fund. If a private fund is selected, the donor has to further select if the private fund is a personal fund or group fund. On the other hand, the system may show up three types of the funds (personal fund, group fund and public fund) for the donor to select at the beginning. The transfer of money to the fund accounts can be made by any payment methods such as online banking, credit cards, POS terminals or PAYPAL, etc. Once a user makes a donation, he/she will become a donor permanently and his/her donation record will be stored in the system. A donor can make multiple donations as well and thus he/she may have multiple fund accounts stored in the system database. Furthermore, the donor can make multiple donations to the same account. When a system member becomes a donor, the system will update the personal information of that system member and open corresponding functions for that system member. After a specific duration, say a month, the system will report to the donor relevant information and update of his/her fund account(s) via email or system message.

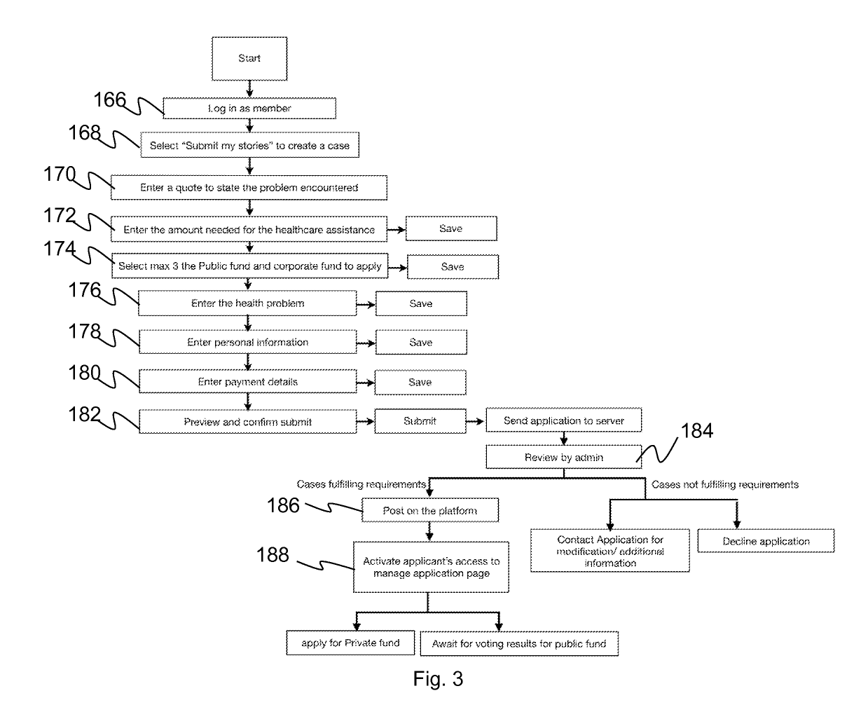

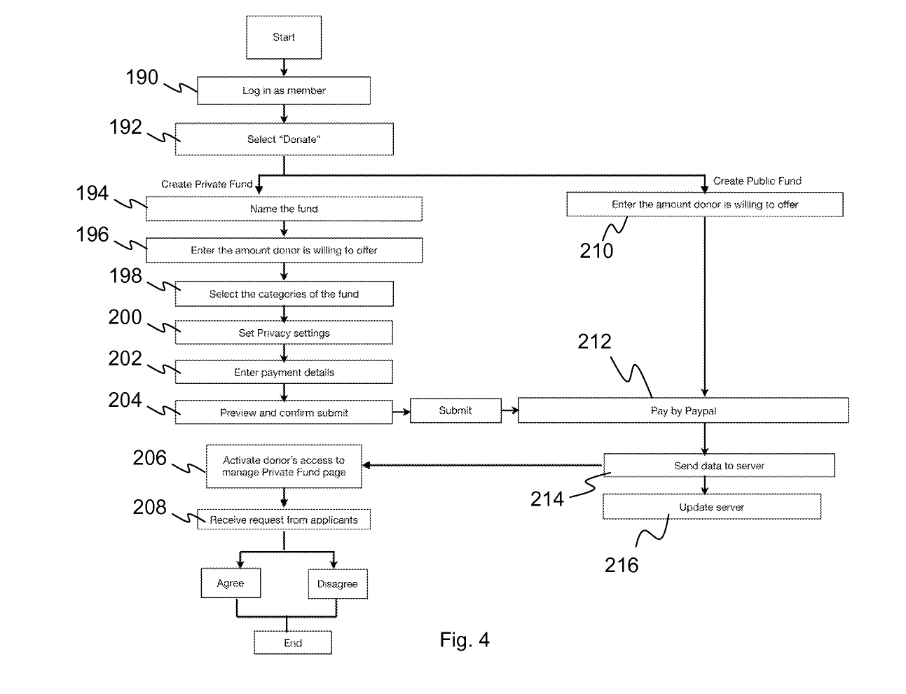

Now turning to FIG. 2b, a flowchart of the operation process of different memberships in one embodiment of the present patent application is shown. The process starts in step 140, i.e. load the webpage of the system or access the system via an application. Then the users have to log into the system as members including general members, donors or applicants in step 142. A donor can proceed to step 144 to browse or manage his/her donation account(s), and for further process, please refer to FIG. 4. The system members can search for cases in step 146, and then sort the results and filter the results by different criteria. The sorting criteria can be the latest application date, the earliest end of application and the highest amount needed, etc. Whereas, the filtering criteria can be ongoing cases, ended cases and successful cases, etc. Based on the sorting and filtering criteria, the donation processing platform 104 will search for correct results and show the results to the users. The cases can be searched here may be limited to those fund accounts open to the public. For the cases that their decision right is on a person or specific groups, the search will not include those cases since other system members do not have the right to approve or disapprove the application thereof. In the search results, the searchers can look into details of a case, e.g. applicant information, application amount, the date of refund etc., by entering into the corresponding application page of that case. The system members can study a case in step 148. If a system member is interested in a specific case, he/she can make a comment on that case in step 156, ask the applicant questions to know more detail of the applicant in step 158, and report abuse by submitting the form to the system in step 160. Abuse reporting is a useful means to prevent dishonest applications and avoid unnecessary waste of the funds. The comments made on the cases, the questions asked by system members and the answers made by the applicants will be saved by the donation processing platform 104 and shown on the corresponding application pages of the cases so that other system members can browse the comments, the questions and the answers as so to make a proper decision. An applicant can invite a friend to prove the authenticity of his/her story. In addition to text reply, an applicant can also upload video or audio to respond to the questions. If a user makes an application of fund, the application is first reviewed by authorized administrators before publishing the application on the platform. The authorized administrators will do the review by checking the documents, confirming the completion and/or conducting an interview with the applicant. Whether to publish the application on the platform is decided by the result of review. If the application does not fulfill the requirements, e.g. missing documents and missing necessary information, the authorized administrators can reject the application or ask the applicant to provide additional information or amend the application data, and this application will not be published on the platform. For those applications that fulfill the requirements, i.e. being complete and verified, the authorized administrators will publish them on the platform so that system members can view them. The donation processing platform 104 supports different languages. If a system member does not know the original language of a specific application, he/she can request the system to provide a translation of the application in step 162 so that he/she can review that case. In step 164, the system members can vote to agree or disagree the application of different cases. For an applicant, he/she can view his/her application page in step 150 to check the status or update his/her information, more detail being shown in FIG. 3.

FIG. 3 is a flowchart of the process of an application of fund in one embodiment of the present patent application. First, the applicant has to log into the system as a member in step 166. Then the applicant needs to go to the application page to select “submit my stories” to create an application case, i.e. step 168. In step 170, the applicant must input the problem encountered, for example, healthcare assistance in this embodiment. After that, the applicant has to enter the amount needed for healthcare assistance in step 172. An applicant may select maximum three funds to apply, i.e. step 174. Next, the applicant can enter more data such as the nature of the health problem, his/her personal information and his/her payment details, etc., i.e. steps 176, 178 and 180. Once a data field is entered, the applicant may save the data in the system before going to next step. If data has been entered, the applicant can preview his/her own application and then submit the application to the system in step 182. After submission, the application will be transferred to the server 102 and then the case will be reviewed by the authorized administrators in step 184. For cases fulfilling the requirements, they will be posted on the platform in step 186 and the corresponding features of the applicants in the system will be activated so that they can go to the application pages to manage their cases in step 188. In the application page, the applicant can select to apply for private fund or make other operations available to him/her. If the applicant has applied for a public fund, he/she needs to wait for voting results. For cases not fulfilling the requirements, the applicant will be notified by the system. The authorized administrators may ask the applicant to modify the application or provide additional information. In some cases, the application will be declined by the authorized administrators.

If an application is approved, the system will notify the applicant and make corresponding arrangement to transfer the amount needed by the applicant. The transfer method can be PAYPAL or other methods. The corresponding amount will be transferred to a specific account but not the own account of the applicant. The specific account is a third party account, e.g. an account of an organization or a person. The organization or person owning the specific account is responsible for delivering the money to the applicant.

Now referring to FIG. 4, a flowchart of the process of donation in one embodiment of the present patent application is shown. If someone wants to make a donation, he/she needs to log into the system as a member first in step 190. After login, the donor has to select “donate” in the system page to make a donation, i.e. step 192. The donor can choose to create a private fund (step 194) or donate to a public fund (step 210). If the donor selects creation of a private fund, he/she needs to give a name to the private fund (step 194), enter the amount that he/she is willing to offer (step 196), select the categories of the private fund (step 198), set his/her privacy settings (step 200), and enter the payment details (step 202). After entering the information, the donor can preview his/her input and then submit the donation application if the information is correct in step 204. Next, the donor should make the payment in step 212 by Paypal or other payment methods. Then the data will be sent to the server 102 in step 214. The information of the donor will be updated by the server 102 (step 216) while the system will activate the donor's access to his/her fund page in step 206. Now the donor's fund account has been set up and the donor can receive fund applications from the applicants in step 208. Based on the donor's judgment, he/she can approve or disapprove the applications. In addition to creation of a private fund, the donor can donate to a public fund. In step 210, the donor should enter the amount willing to offer and make the payment by Paypal or other methods in step 212. Similarly, after the payment, the data will be sent to the server 102 and then the server 102 will update the donor's information and activate the donor's access to the fund page. When receiving applications, the donor can vote to agree or disagree the application of the public fund.

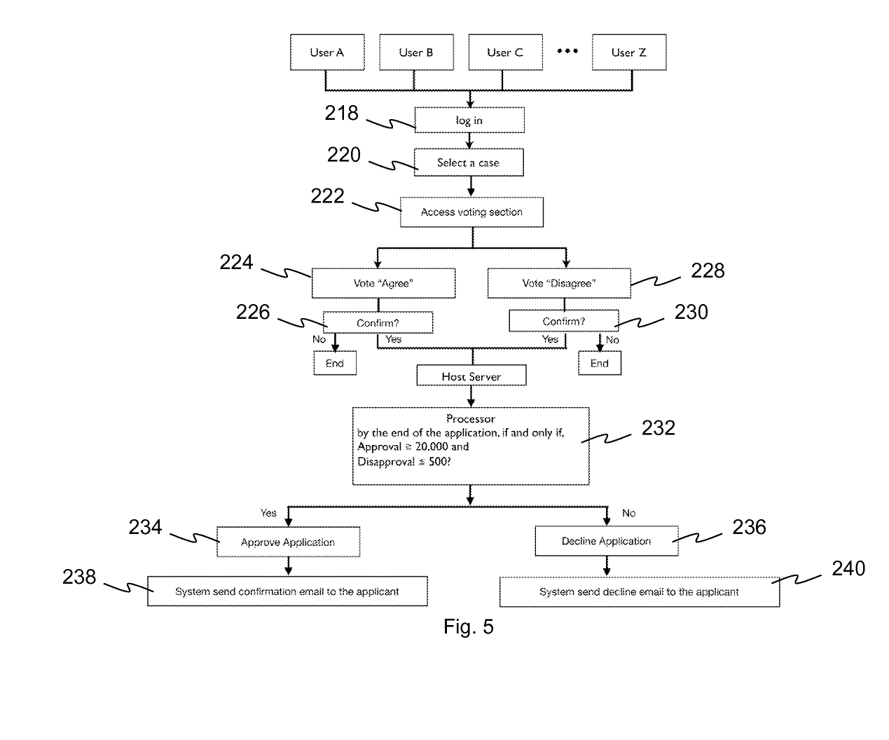

FIG. 5 shows the public assessment process in one embodiment of the present patent application. For the system members having the right for voting for public funds, they first need to log into the system in step 218. Then the system members select a case in step 220 to access to the voting section in step 222. After analyzing the story of the applicant, e.g. the problem encountered, the amount needed, etc., the system members can vote “agree” in step 224 or vote “disagree” in step 228. If the vote is not confirmed in steps 226 or 230, the process is ended. On the other hand, if the vote is confirmed in steps 226 or 230, the voting record will be sent to the server 102. The system will allocate a vote accumulator for each application. Once a vote is received, the system will update the vote accumulator to keep track of the voting process. At the end of the application (i.e. after a predetermined period such as one month), the processor of the server 102 will execute a predefined rule to analyze the voting result in step 232. In this specific embodiment, the predefined rule is that the application can be approved if and only if approval votes are equal to or more than 20,000 (i.e. approval votes ≧20,000) and disapproval votes are equal to or less than 500 (i.e. disapproval votes 500). If the above rule is satisfied, the application will be approved by the system in step 234, otherwise, the application will be declined by the system in step 236. Once the result is out, the system will send confirmation email to the applicant to notify the approval in step 238 or send decline email to the applicant to notify the disapproval in step 240. In-person contact or face-to-face online contact may be conducted by the authorized administrators as well.

Based on different decision rights, different presentation modes are designed by the system so as to facilitate the approval decision making If the approval of a fund is decided by the public, including public fund and private fund approved by the public, the system will generate a specific presentation page of the application which contains a vote button for the system members going into the correct pages to browse the relevant information of the application and vote for approval or disapproval. If the approval of a private fund is decided by a group, the system will update the corresponding presentation pages of the group members so that the group members can view the relevant information of the private fund and carry out voting. Similarly, if the approval of a private fund is decided by a person, the system will update the corresponding presentation page of the person so that that person can view the relevant information of the private fund and approve or disapprove the application. On the other hand, the system can send system message directly to the person to notify him/her. The system message may contain relevant information and direct link for the person to approve or disapprove the application.

The exemplary embodiments of the present patent application are thus fully described. Although the description referred to particular embodiments, it will be clear to one skilled in the art that the present patent application may be practiced with variation of these specific details. Hence this patent application should not be construed as limited to the embodiments set forth herein.

The predefined rule can be amended due to different circumstances. Based on needs, the predefined rule can be simple or complex. For example, the predefined rule can be that the application will be approved if the approval votes are more than 20,000 for amount needed is below USD10,000. The predefined rule can be also that the application will be approved if the approval votes are more than 20,000 for amount needed is between USD10,000 and USD100,000.

What is claimed is:

1. A system for processing donations comprising:
a donation processing platform configured to communicate with user devices via a data communication channel;
wherein the donation processing platform manages a plurality of fund accounts open for applications by users who are system members of the donation processing platform; the users accessing to the donation processing platform through the user devices; the users having different right and restriction due to different types of the system members; approval of the applications being made under different criteria based on different categories of the fund accounts;
wherein if the application is approved, approved amount is first transferred to a third party account of an organization or a person responsible for delivering the approved amount to a user account of the user of the application; and
wherein donations, the applications and the approval of the applications are made by the system members.

2. The system of claim 1, wherein the different types of the system members are general member, donor and applicant; the general member being the system member who does not have any the donation or the application; the donor being the system member who makes at least one the donation; the applicant being the system member who has made at least one the application; and the users being capable of being as multiple types of the system members simultaneously.

3. The system of claim 2, wherein the fund accounts are classified into private funds and public funds; the private funds having personal funds and group funds;
wherein the personal fund is created by a donor; the personal fund being managed by the donor personally and approval of application of the personal fund being made by the donor;
wherein the group fund is created by at least one the donor who has administration authority of the group fund; the group fund being managed by a specific group and approval of application of the group fund being made by members in the specific group; and
wherein the public fund is created by the donation processing platform and approval of application of the public fund is made by voting of the system members under a predefined rule.

4. The system of claim 3, wherein the predefined rule is that the application of the public fund is approved if and only if approval votes are equal to or more than 20,000 and disapproval votes are equal to or less than 500.

5. The system of claim 2, wherein management and operation of the donation processing platform are done by authorized administrators; the donations being reviewed and approved by the authorized administrators; and the applications being previewed by the authorized administrators before publishing on the donation processing platform.

6. The system of claim 1, wherein the system member is able to view the applications in the donation processing platform, make comments on the applications and report hidden fact and lying to the donation processing platform to prevent dishonest applications and unnecessary waste of funds.

7. The system of claim 1, wherein the donation processing platform supports filtering and sorting of the applications based on input of the system members; and results of the filtering and sorting of the applications including summary of specific applications and being linked to corresponding presentation pages of the specific applications.

8. The system of claim 1, wherein the donation processing platform is housed in a local server or a cloud server which is an integration of multiple servers connected by wired or wireless technology.

9. The system of claim 1, wherein the user devices comprise computers and mobile devices; the computers comprising desktops and notebooks that run operating system of WINDOWS or OS X; and the mobile devices comprising PDA, tablet computers and smart phones that run operating system of IOS or ANDROID.

10. The system of claim 1, wherein the data communication channel comprises Internet and mobile network of GSM, GPRS, CDMA or WIFI.

11. A method for processing donations comprising:
a) providing a donation processing platform which manages a plurality of fund accounts open for applications by users who are system members of the donation processing platform;
b) accessing to the donation processing platform through user devices via a data communication channel;
c) logging into the donation processing platform as the system members;
d) making donations, the applications and approval of the applications by the system members;
wherein users have different right and restriction due to different types of the system members; the approval of the applications being made under different criteria based on different categories of the fund accounts; and
wherein if the application is approved, approved amount is first transferred to a third party account of an organization or a person responsible for delivering the approved amount to a user account of the user of the application.

12. The method of claim 11, wherein the different types of the system members are general member, donor and applicant; the general member being the system member who does not have any the donation or the application; the donor being the system member who makes at least one the donation; the applicant being the system member who has made at least one the application; and the users being capable of being as multiple types of the system members simultaneously.

13. The method of claim 12, wherein the fund accounts are classified into private funds and public funds; the private funds having personal funds and group funds;
wherein the personal fund is created by a donor; the personal fund being managed by the donor personally and approval of application of the personal fund being made by the donor;
wherein the group fund is created by at least one the donor who has administration authority of the group fund; the group fund being managed by a specific group and approval of application of the group fund being made by members in the specific group; and
wherein the public fund is created by the donation processing platform and approval of application of the public fund is made by voting of the system members under a predefined rule.

14. The method of claim 13, wherein the predefined rule is that the application of the public fund is approved if and only if approval votes are equal to or more than 20,000 and disapproval votes are equal to or less than 500.

15. The method of claim 12, wherein management and operation of the donation processing platform are done by authorized administrators; the donations being reviewed and approved by the authorized administrators; and the applications being previewed by the authorized administrators before publishing on the donation processing platform.

16. The method of claim 11, wherein the system member is able to view the applications in the donation processing platform, make comments on the applications and report hidden fact and lying to the donation processing platform to prevent dishonest applications and unnecessary waste of funds.

17. The method of claim 11, wherein the donation processing platform supports filtering and sorting of the applications based on input of the system members; results of the filtering and sorting of the applications including summary of specific applications and being linked to corresponding presentation pages of the specific applications.

18. The method of claim 11, wherein the donation processing platform is housed in a local server or a cloud server which is an integration of multiple servers connected by wired or wireless technology.

19. The method of claim 11, wherein the user devices comprise computers and mobile devices; the computers comprising desktops and notebooks that run operating system of WINDOWS or OS X; and the mobile devices comprising PDA, tablet computers and smart phones that run operating system of IOS or ANDROID.

20. The method of claim 11, wherein the data communication channel comprises Internet and mobile network of GSM, GPRS, CDMA or WIFI.
